(19) United States
(12) Patent Application Publication
(10) Pub. No.: US 2006/0159822 A1
(43) Pub. Date: Jul. 20, 2006

(54) Customizable consumer product system and method

(76) Inventor: Mahesh Galal, Center, TX (US)

Correspondence Address: P.E. Caldwell, Esq., Suite 400, 8080 N. Central Expressway, Dallas, TX, 75206, US

(21) Appl. No.: 11/039,169

(22) Filed: Jan. 20, 2005

(51) Int. Cl. A23L 1/05; A23L 1/40

(52) U.S. Cl. 426/573; 426/589

(57) ABSTRACT

The present invention provides for a consumer product comprising a base product. The base product comprises one or more base characteristics and at least one variable characteristic with an intensity at a low end of a range of intensities. An additive product comprises the variable characteristic and at least one of the one or more base characteristics. The additive product is configured to increase the intensity of the variable characteristic towards a high end of the range of intensities when combined with the base product to form a resultant product.

### TECHNICAL FIELD

The present invention relates generally to the field of manufacturing and distributing consumer products and, more particularly, to a customizable consumer product system and method.

### BACKGROUND

Modern products are often packaged and/or marketed as a family or group of similar products. Often, each product in a family or group of products is packaged and marketed as a discrete product- with characteristics common to all products in the family or group and custom characteristics unique to the particular discrete product. For example, a family of salsa dip products can include variations of the same basic salsa or recipe, based on the spiciness of the variation. For example, a salsa dip product family can include a mildly-spicy or “mild salsa,” a medium-spicy or “medium salsa,” and a very-spicy or “hot salsa,” with each variation packaged in a separate package or container.

Thus, a consumer in a grocery store shopping for salsa, for example, would observe three different containers on the shelf, one for each variation of the salsa in the product family. Typically, each salsa product variation would taste more or less the same to the consumer, as each variation is ordinarily based on substantially the same base recipe, except for the spiciness of the particular salsa product variation.

Similarly, in another example, a family or group of laundry detergent or other household cleaning products can include one or more discrete products that each have a common laundry detergent or cleaning composition, with individual products also containing a unique fragrance characteristic or scent. Similarly, in another example, a family or group of salad dressings can include one or more discrete products that each have a common flavor, with individual products containing more or less of a high-caloric ingredient characteristic, such as, for example, a fat content.

Generally, product families are often developed from a commercially successful base product. Additional products in the product family are often inspired by one or more individual modifications to the base product, often based on expressed consumer desire, other feedback, and/or innovation or technical advances. If the base product is successful, the manufacturer will often introduce additional products based on the base product, sometimes requiring only minimal additional manufacturing process steps. For example, a family of snack foods can be developed from a single base product, such as, for example, a “plain”-flavor potato chip with a unique shape. Additional products in the family can include different flavors of the uniquely shaped chip, with the flavor variations achieved by dusting the plain-flavored potato chip with a flavored powder that adheres to the potato chip. Thus, manufacturers often supply a family of products that offer consumers or other purchasers the same basic advantages and/or characteristics associated with a base product, allowing the consumer to select from a variety of variations on the base product.

Furthermore, a consumer may not be certain as to how much of a particular product the consumer needs, and therefore does not wish to buy a full package of a product when the consumer is not certain whether the full amount will be necessary. For example, a consumer planning a party may wish to have a variety of different types of salsa available to the event goers, but is unsure as to how much of each of hot, mild, and medium-spicy salsa to purchase and/or make available to the guests. Thus, the consumer can be faced with deciding between purchasing too little of a desired salsa, leaving the guests under-supplied of their preferred salsa, or purchasing too much of a less-desired salsa, resulting in waste and/or excess cost.

Additionally, consumers often desire individual features or characteristics of one or more variations within a product family, but sometimes none of the variations offered by the manufacturer provide a single product with all of the features and/or characteristics the consumer desires. Similarly, consumers sometimes would prefer a variation of the base product that is not offered as one of the variations on the product. For example, a carbonated beverage product family can include a base product cola and variations of the base product cola including a “diet” or reduced calorie cola, a cola with lemon flavoring, a cola with vanilla flavoring, a cola with reduced or no caffeine, a diet cola with reduced or zero caffeine, and so forth. A consumer might wish to purchase a diet caffeine-free lemon-flavored cola, but the variations offered by the manufacturer only include a diet cola, a diet caffeine-free cola, and a diet lemon-flavored cola.

Thus, the consumer can be faced with deciding which of the desired characteristics to forgo, choosing from among the offered base product and base product variations, none of which completely meet the consumer's desired attributes. Alternatively, consumers sometimes attempt to reformulate a product by combining one or more products in a product family, in an effort to produce a resultant product that includes all of the consumer's desired attributes and/or characteristics. For example, a consumer might combine a diet caffeine-free cola with a diet lemon-flavored cola in an attempt to produce a desired diet caffeine-free lemon-flavored cola. However, such attempts often result in a resultant product that still does not quite meet the consumer's desired product characteristics.

Moreover, over time, particular products in a family of similar products are sometimes modified with new characteristics added and/or removed by the manufacturer, or particular products discontinued altogether. For example, a manufacturer may not wish to offer, or continue to offer, a product with a particular set of characteristics where the likely or existing consumer purchaser base is too low to support the cost to produce the particular product. Therefore, such an individual customization, providing a family of consumer products that together are completely satisfactory to each customer, may not be economically feasible.

Thus, manufacturers sometimes offer a base product as an unfinished product, which the consumer or end-user can modify with a consumer-provided additive to adjust a particular characteristic to the consumer's desired result. However, relying on end-users to provide additives can result in wide variation in the resultant product, and/or additional complexity in using the product. Wide variations in the resultant final product can cause the result that the user cannot be confident that the resultant product will be substantially the same resultant product each time the end-user modifies the base product. Also, the manufacturer might want to ensure the quality of the resultant product, which can be particularly difficult if the end-user supplies the additive.

Similarly, other attempts to provide increased user-customization of a base product often result in variations of the characteristics in the resultant end product that are undesirable to the manufacturer, consumer, and/or end-user. Also, many efforts at providing user-customization require additional steps or manipulations of the product that are burdensome or overly complicated to the end-user, potentially making the benefits of user-customization substantially outweighed by the inconvenience or difficulty in using the product.

Additionally, some user-customizable products that include a manufacturer-supplied additive do not provide a simple or convenient way for the end-user to customize, or otherwise combine the products, to create the resultant product. Previous attempts to package an additive or customization component with a base product often lack a mechanism by which end-users can be confident that customization of the base product to the resultant product is repeatable, or otherwise provides a-degree of predictability.

Therefore, there is a need for a system and/or method for a customizable consumer product that addresses at least some of the problems and disadvantages associated with conventional systems and methods.

### SUMMARY

The present invention provides for a consumer product comprising a base product. The base product comprises one or more base characteristics and at least one variable characteristic with an intensity at a low end of a range of intensities. An additive product comprises the variable characteristic and at least one of the one or more base characteristics. The additive product is configured to increase the intensity of the variable characteristic towards a high end of the range of intensities when combined with the base product to form a resultant product.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a customizable consumer product;

FIG. 2 is a block diagram depicting a customizable consumer product;

FIG. 3 is a flow diagram depicting a customizable consumer product method; and

FIG. 4 is a flow diagram depicting a customizable consumer product-method.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail.

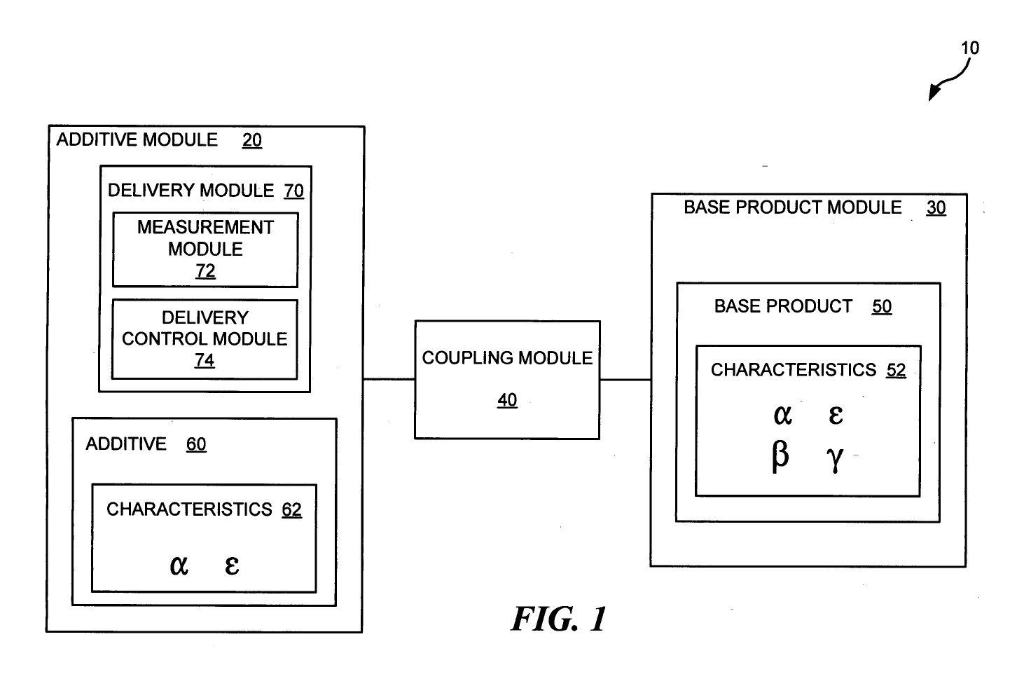

Referring to FIG. 1 of the drawings, the reference numeral 10 generally designates a consumer product. Consumer product 10 includes additive module 20, base product module 30, and coupling module 40. Generally, additive module 20 and base product module 30 are packages, containers, or other suitable devices and are configured to store or otherwise enclose a product. In particular, additive module 20 and base product module 30 are configured to store or otherwise enclose an additive and a base product, respectively, as described in more detail below. Generally, coupling module 40 is any device suitable to couple additive module 20 and base product module 30. In a particular embodiment, coupling module 40 is a discrete component of consumer product 10. In an alternate embodiment, coupling module 40 can be configured as a component of additive module 20 and/or base product module 30. In one embodiment, additive module 20 and base product module 30 can include one or more components of coupling module 40. It will be understood to one skilled in the art that other configurations can also be employed.

Additive module 20 includes additive 60. In a particular embodiment, additive 60 includes characteristics 62. Generally, characteristics 62 are definable traits, characteristics, attributes, or other suitable descriptive variables of additive 60. In a particular embodiment, characteristics 62 include characteristic alpha and characteristic epsilon. It will be understood to one skilled in the art that additive 60 can include additional characteristics. Similarly, base product module 30 includes base product 50. In a particular embodiment, base product 50 includes characteristics 52. Generally, characteristics 52 are definable traits, characteristics, attributes, or other suitable descriptive variables of base product 50. In a particular embodiment, characteristics 52 include characteristic alpha, characteristic beta, characteristic gamma, and characteristic epsilon. It will be understood to one skilled in the art that base product 50 can include additional characteristics.

In one embodiment, characteristic alpha and characteristic epsilon are variable characteristics and characteristic beta and characteristic gamma are base characteristics. Generally, base characteristics are characteristics that are desired to be substantially similar in both base product 50 and a resultant product formed by combining base product 50 with additive 60. For example, in one embodiment, where characteristic gamma is a viscosity, or thickness, the viscosity gamma of base product 50 and additive 60 is such that when combined, the viscosity of the resultant product is substantially similar to the viscosity gamma of base product 50. Generally, variable characteristics are characteristics that are desired to be dissimilar as between base product 50 and a resultant product formed by combining base product 50 and additive 60. Thus, for example, in an embodiment where characteristic epsilon is a viscosity, the viscosity epsilon of base product 50 is not the same as the viscosity epsilon of additive 60, and the viscosity characteristic epsilon of the resultant product is at an intensity between the viscosity epsilon of base product 50 and additive 60. It will be understood to one skilled in the art that other configurations can also be employed.

Generally, additive 60 is configured so that when a unit of additive 60 is combined with a unit of base product 50, the resultant product includes base characteristics that are substantially similar to the base characteristics of base product 50 and variable characteristics that include an intensity at a high end of a range of characteristic intensities. As used herein, a “unit” is a predetermined amount of a product. Generally, a characteristic intensity is a relative measure of a value, intensity, or other quantification of a characteristic. For example, in one embodiment, the intensity of a spiciness characteristic is a measure of how spicy a product with a particular spiciness characteristic tastes to a consumer. Thus, for example, a low end of a range of intensities of a spiciness characteristic can be a mildly-spicy product, and a high end of a range of intensities of the spiciness characteristic can be a very-spicy product. It will be understood to one skilled in the art that other configurations can also be employed. Additionally, the range of intensities can be based on a somewhat subjective experience of typical consumers, or can be a predefined, measurable amount, such as, for example, parts per million (ppm) of a content or ingredient in the base product and/or additive. It will be understood to one skilled in the art that other suitable bases can also be employed.

The specific nature of the characteristics can be based on the consumer product 10. For ease of understanding, the specific nature of the characteristics appropriate for a salsa dip product, for example, are described below. It will be understood to one skilled in the art that the specific characteristics for other products will vary, as described in more detail below. Thus, for example, in one embodiment, characteristic alpha is a spiciness characteristic, characteristic beta is a flavor characteristic, characteristic gamma is a tomato-content characteristic, and characteristic epsilon is a viscosity characteristic. In a particular embodiment, additive 60 is configured such that when combined with a base product 50 with a spiciness characteristic at a low end of a range of intensities, the resultant product includes a flavor characteristic and a tomato-content characteristic that are substantially similar to base product 50, and a spiciness characteristic at a high end of the range of intensities. Additionally, additive 60 can be configured with a viscosity characteristic such that when combined with a base product 50 with a viscosity characteristic at a particular intensity, the resultant product includes a viscosity characteristic at a substantially similar intensity to the base product 50. In an alternate embodiment, additive 60 can be configured with a viscosity characteristic such that when combined with a base product 50 with a viscosity characteristic at a particular intensity, the resultant product includes a viscosity characteristic at a substantially higher or lower intensity than the base product 50. It will be understood to one skilled in the art that other configurations can also be employed.

As described above, characteristics 52 and characteristics 62 can vary based on the nature of the consumer product 10. For example, consumer product 10 can be any of a variety of sauces, such as salad dressings, BBQ sauces, steak sauces, condiment combinations, Teriyaki sauces, Soy sauces, cheese sauces, other dips, spaghetti sauces, cocktail sauces, or other suitable sauces. Thus, it will be understood to one skilled in the art that in one embodiment, characteristic alpha can be a spiciness, and characteristic gamma, the particular flavor, can vary from product to product based on the type of sauce consumer product 10 is.

Furthermore, consumer product 10 can be a variety of consumer products, with the specific characteristics based on the desired base product and additive. Thus, additive 60 can be configured to modify the desired particular characteristic based on the underlying base product. Additionally, additive 60 can comprise a suitable additive to yield a particular set of characteristics in a resultant product when combined with base product 50. For example, where consumer product 10 is a juice drink, base product 50 can be a product made of various fruit and/or vegetable juices, and additive 60 can be configured as liquefied extracts or aqueous spices or other additives. In another example, where consumer product 10 is a jelly or jam, base product 50 can be a jam or jelly and additive 60 can be configured as a puree or other form of various flavors and/or sweetness levels.

Thus, generally, consumer product 10 can be a consumer product with a base product 50 that can be modified or customized by an appropriately selected additive 60. For example, consumer product 10 can be a ship or snack cracker that can be customized by the addition of cheese, spices, and/or salt, as dictated by taste preference and/or dietary needs, such as, for example, as can be desired by hypertensive, CHF, or renal-sensitive consumers. In another example, consumer product 10 can be a milk product and customized by addition of higher-fat-content milk. In another example, consumer product 10 can be a chili product and customized by addition of spices to vary the spiciness of the resultant product. In another example, consumer product 10 can be a tomato-based product and customized by the addition of varying levels of additional spices.

In another example, consumer product 10 can be a beverage mixer and customized by addition of one or more spices, juices, and/or sauces. In another example, consumer product 10 can be a nutrient replacement beverage and customized by addition of one or more electrolyte and/or nutrient additives and/or flavor-additives. In another example, consumer product 10 can be a seasoning and customized by addition of one or more spices. Thus, it will be understood to one skilled in the art that consumer product 10 can be configured to address a wide variety of consumer customization desires, as described in more detail below.

In one embodiment, characteristics 62 of additive 60 are configured to increase characteristic alpha and characteristic epsilon of base product 50, such that the resultant product includes a linear increase in characteristic alpha and characteristic epsilon, with substantially constant characteristics beta and gamma. As used herein, substantially constant characteristics are characteristics that do not change more than 1% between the base product and the resultant product. In one embodiment, characteristics 62 of additive 60 are configured to increase characteristic alpha and characteristic epsilon of base product 50, such that the resultant product includes an exponential increase in characteristic alpha, and a linear increase in characteristic epsilon, with substantially constant characteristics beta and gamma. It will be understood to one skilled in the art that other configurations can also be employed.

Consumer product 10 also includes delivery module 70. In the illustrated embodiment, delivery module 70 is depicted as a component of additive module 20. In an alternate embodiment, delivery module 70 can be a component of base product module 30, a component of coupling module 40, a separate component of consumer product 10, or otherwise suitably configured. It will be understood to one skilled in the art that other configurations can also be employed.

Delivery module 70 includes measurement module 72 and delivery control module 74. Measurement module 72 is any suitable device configured to identify a portion or subunit of additive 60. In one embodiment, measurement module 72 can be a series of gradation marks identifying relative portions of additive 60. In an alternate embodiment, measurement module 72 can be a set of partitions that divide additive 60 into subunits. In a particular embodiment, measurement module 72 is a set of partitions of additive module 20 that divide additive 60 into four substantially equivalent compartments. It will be understood to one skilled in the art that other configurations can also be employed.

Delivery control module 74 is any suitable device configured to modulate, regulate, or otherwise control removal of additive 60 from additive module 20. In one embodiment, delivery control module 74 is an aperture with a controllable iris. In an alternate embodiment, delivery control module 74 is a plunger configured to move additive 60 through an aperture. It will be understood to one skilled in the art that other configurations can also be employed.

In the illustrated embodiment, measurement module 72 and delivery control module 74 are depicted separate components. In an alternate embodiment, measurement module 72 and delivery control module 74 can be combined into a single module, or one or more of measurement module 72 and delivery control module 74 can be combined with additive module 20, base product module 30, and/or coupling module 40. It will be understood to one skilled in the art that other configurations can also be employed.

Generally, in operation, a unit or portion of additive 60 is combined with or added to base product 50. As described above, a unit can be an amount of additive 60 that is the entirety of additive 60 of additive module 20. A portion can be a graduated amount or subunit of additive 60 or a predetermined set portion of additive 60. In one embodiment, where additive 60 is partitioned into subunits through measurement module 72, a consumer can elect to add one or more subunits of additive 60 to base product 50, to provide a resultant product with the consumer's desired characteristic intensities. For example, where consumer product 10 is a salsa dip product and additive 60 is partitioned into three subunits, a consumer can elect to add no subunits to produce a very mild salsa, one subunit to produce a mild salsa, two subunits to produce a medium spicy salsa, and three subunits to produce a very spicy salsa. It will be understood to one skilled in the art that other configurations can also be employed. Thus, additive 60 to be combined with base product 50 in a quantifiable ratio/amount, so that the-consumer can add additive 60 to base product 50, based on the consumer's desired resultant-product characteristics, with control through delivery control module 74.

Additionally, additive 60 can be combined with base product 50 in base product module 30. Thus, base product module 30 can be configured as a container in which base product 50 is stored, with spare storage capacity to contain a unit of additive 60. Thus, in one embodiment, additive 60 and base product 50 can be combined in base product module 30 to yield the resultant end product. Additionally, base product 50 and some or all of additive 60 can be combined in a separate container and/or bowl.

In the illustrated embodiment, consumer product 10 is depicted with one base product module 30 and one additive module 20. In an alternate embodiment, consumer product 10 can be configured with a plurality of additive modules 20. In a particular embodiment, the plurality of additive modules 20 together comprise a unit of additive 60. It will be understood to one skilled in the art that other configurations can also be employed.

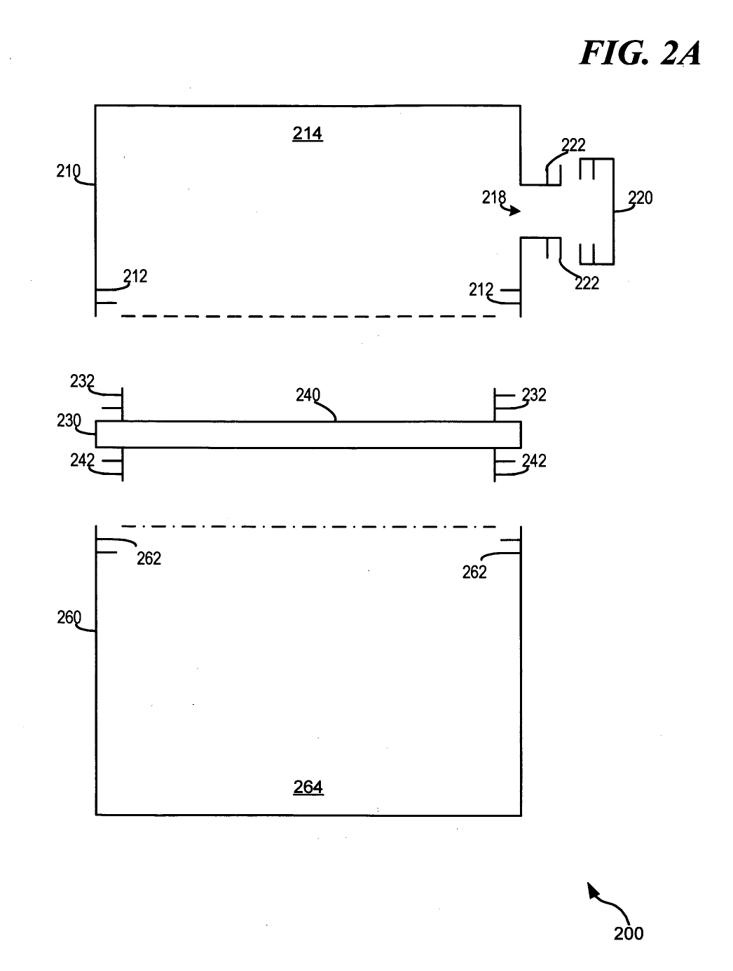

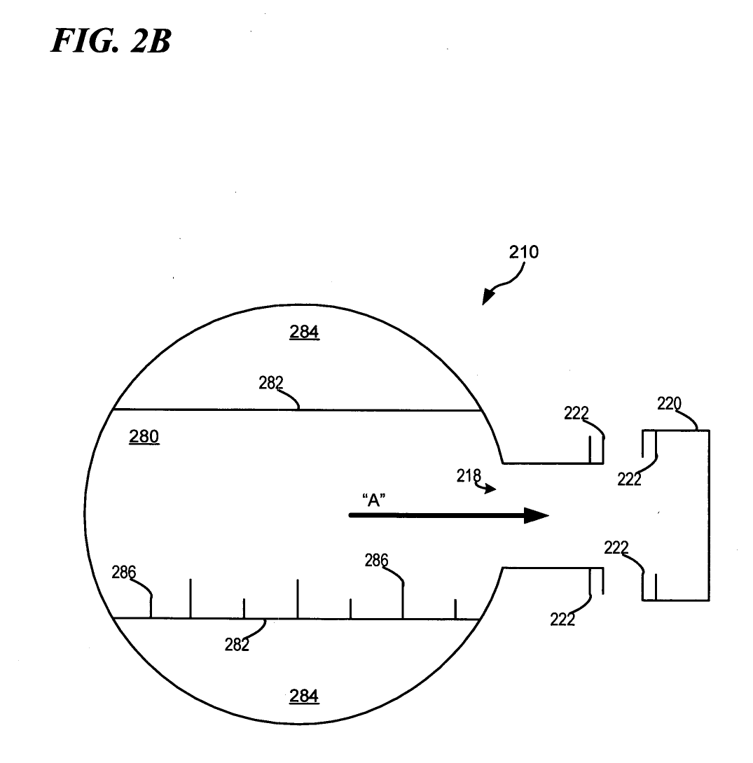

Referring now to FIG. 2A of the drawings, the reference numeral 200 generally designates a consumer product. Consumer product 200 includes additive module 210, coupling module 230, and base product module 260. Additive module 210 includes threads 212. Threads 212 are circular threads, or other suitable threads, and are configured to couple to, or otherwise interlock with, corresponding threads of coupling module 230. Generally, additive module 210 is configured to store an additive 214. As described above, additive 214 is an additive configured with a set of characteristics such that when added to a base product, increase an intensity of a variable characteristic of the base product in the combined or resultant product. Additive module 210 includes aperture 218, through which additive 214 can flow or pass.

Consumer product 200 includes cap 220. Cap 220 is a cap, seal, or other suitable device, and is configured to be coupled to additive module 210, through threads 222, thereby closing or blocking aperture 218 to enclose additive 214. Threads 222 are circular threads or other suitable threads, and are configured to couple cap 220 to additive module 210, so as to restrict flow of additive 214 through aperture 218. It will be understood to one skilled in the art that other configurations can also be employed.

Coupling module 230 includes threads 232. Threads 232 are circular threads, or other suitable threads, and are configured to interlock with threads 212 of additive module 210. Thus, coupling module 230 and additive module 210 can be coupled together to store additive 214. In the illustrated embodiment, a dashed line of additive module 210 indicates the approximate location of a barrier that is formed when additive module 210 is coupled to coupling module 230. In particular, when additive module 210 is coupled to coupling module 230, through interlocking of threads 212 and threads 232, a partition 240 of coupling module 230 serves as a barrier, along with cap 220, to enclose or store additive 214. It will be understood to one skilled in the art that other configurations can also be employed.

Base product module 260 includes threads 262. Threads 262 are circular threads, or other suitable threads, and are configured to interlock with reciprocal or complementary threads of coupling module 230. In particular, threads 262 are configured to interlock with threads 242 of coupling module 230. A dashed line of base product module 260 indicates the approximate location of a barrier that is formed by partition 240 when coupling module 230 is coupled to base product module 260, through interlocking of threads 242 and threads 262. Thus, base product module 260 can be configured to store a base product 264. In particular, additive module 210, as coupled to coupling module 230, is configured to store an additive 214. Similarly, base product module 260 as coupled to coupling module 230, is configured to store a base product 264. It will be understood to one skilled in the art that other configurations can also be employed.

Generally, in operation, consumer product 200 is configured to store a base product and an additive as a single package. Therefore, a consumer or end-user can retrieve the base product 264 stored in base product module 260, and combine base product 264 with additive 214, stored in additive module 210. In particular, a consumer or end-user can access additive 214 by removing cap 220, thereby allowing additive 214 to flow through aperture 218, or can de-couple additive module 210 and coupling module 230.

Additionally, in one embodiment, base product module 260 is configured to store or enclose a volume equivalent to one unit of base product and one unit of additive product. Thus, a consumer or end-user can de-couple coupling module 230 and base product module 260, remove cap 220, and orient aperture 218 so that additive 214 can flow into base product module 260, thereby combining with base product 264. It will be understood to one skilled in the art that the orientation of aperture 218 can provide an amount of control over the volume of additive 214 that flows through aperture 218. Thus, the consumer or end-user can combine some, all, or none of additive 214 with base product 264, as described in more detail below.

In one embodiment, aperture 218 can be designed based on a viscosity characteristic of additive 214. In a particular embodiment, aperture 218 is configured so that additive 214 can flow through aperture 218 at a particular rate, wherein the rate is selected based on a desired constant, manageable flow. It will be understood to one skilled in the art that other configurations can also be employed.

Furthermore, consumer product 200 can be configured as a reusable container to store a base product and an additive in separate compartments. In particular, for example, base product module 260 can be employed to store a base product, enclosed by coupling base product module 260 to coupling module 230. Additionally, additive module 210 can be de-coupled from coupling module 230, and refilled with additional additive 214, or other suitable product, and re-coupled to coupling module 230, to store an additive 214. Thus, a user can employ additive module 210 to store additives 214, for subsequent delivery or combination with a base product 264.

Referring now to FIG. 2B of the drawings, the reference numeral 210 generally designates an additive module, such as, for example, additive module 210 of FIG. 2A, depicted in top view. As described above, additive module 210 includes a cap 220 and threads 222, through which cap 220 can be coupled to additive module 210, to provide an enclosed container in which to store additive product 214. In particular, additive module 210 includes measurement compartment 280. In the illustrated embodiment, measurement compartment 280 is generally defined by side walls 282. Therefore, additive 214 can be stored between side walls. 282 in compartment 280 for subsequent delivery through aperture 218 along arrow “A”. It will be understood to one skilled in the art that other configurations can also be employed.

Therefore, it will be understood to one skilled in the art that side walls 282 form compartment 280, wherein additive 214 can be stored, thereby leaving compartments 284 relatively empty of additive 214. It will be understood to one skilled in the art that other configurations can also be employed.

Additionally, compartment 280 can be configured with gradation marks 286. Generally, gradation marks 286 are marks or other indicators displaced along compartment 280, and configured to assist a consumer in identifying a relative portion of additive 214. As described above, a consumer can combine a known portion of additive 214 with a base product, to provide a desired attribute, or characteristic intensity, in the resultant product. For example, a midpoint gradation mark can be employed to indicate to the consumer that the additive amount represented by the midpoint gradation mark 286 will result a final product with the variable characteristic halfway between a low end of the range of characteristic intensities and a high end of the range of characteristic intensities. Thus, gradation marks 286 can be employed to assist a consumer to disburse a particular portion of additive 214 through aperture 218, to provide an approximate predetermined desired customization result.

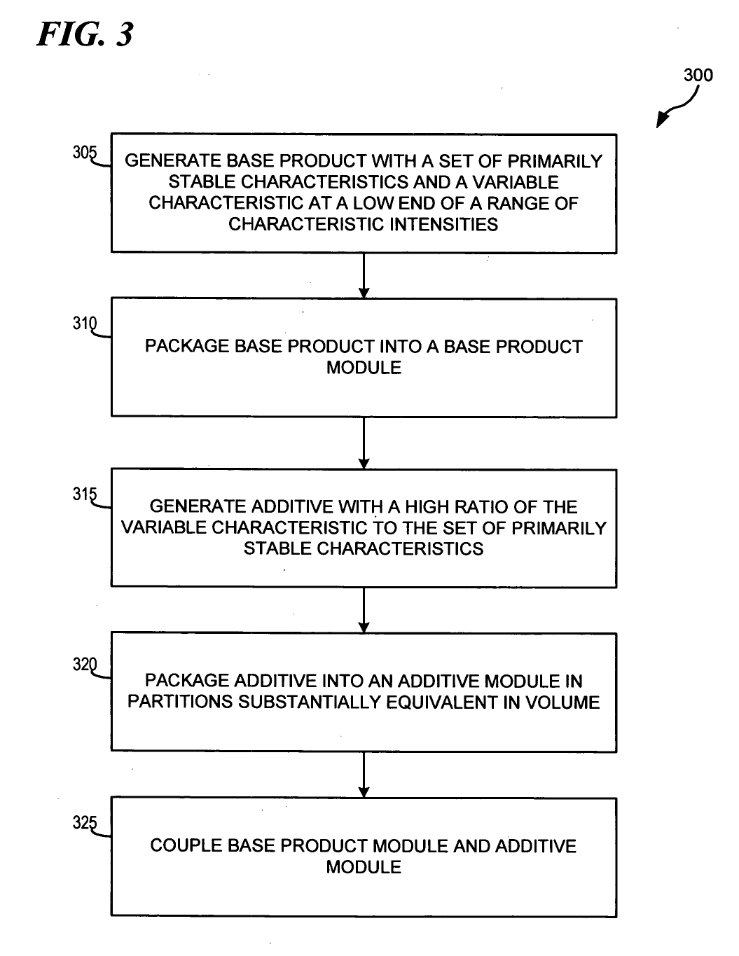

Referring to FIG. 3 of the drawings, the reference numeral 300 generally designates a flow diagram depicting a method for providing a consumer product in accordance with one embodiment of the present invention. The process begins at step 305, wherein a base product is generated. Step 305 includes configuring the base product with a set of primarily stable, or base, characteristics and at least one variable characteristic at a low end of a range of characteristic intensities. As described above, this step can include identifying a variable characteristic of a base product, based on consumer input, or other design specifications, as will be understood by one skilled in the art.

At next step 310, the base product is packaged into a base product module. At next step 315, an additive is generated, with a high ratio of the variable characteristic to the set of primarily stable, or base, characteristics. As described above, the additive can be configured to increase the intensity of the variable characteristic, while maintaining the base characteristics substantially within a range of values that are substantially indistinguishable in the resultant product to the consumer. It will be understood to one skilled in the art that other configurations can also be employed.

At next step 320, the additive is packaged into an additive module. In a particular embodiment, the additive is packaged into, an additive module in partitions that are substantially equivalent in volume. Thus for example, the additive can be packaged into an additive module in one-quarter partitions. That is, each of the partitions of the additive module are substantially equivalent, the totality of which include or otherwise comprise a unit of the additive. As described above, a unit of the additive is configured to, when combined with a unit of the base product, result in an end product with a variable characteristic intensity at a high end of the range of characteristic intensities. It will be understood to one skilled in the art that other configurations can also be employed. At next step 325, the base product module and the additive module are coupled, and the process ends.

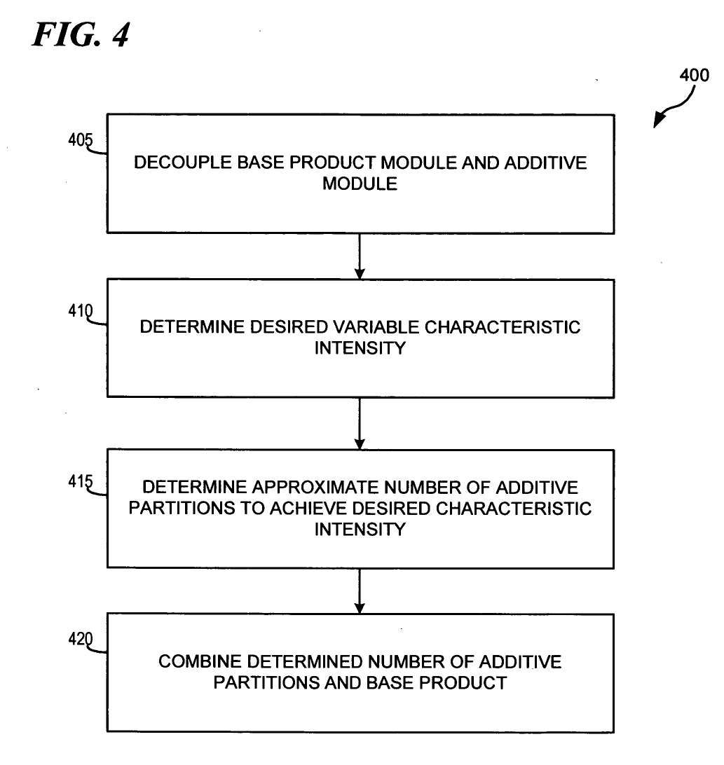

Referring to FIG. 4 of the drawings, the reference numeral 400 generally designates a flow diagram depicting a method for using a consumer product in accordance with one embodiment of the present invention. The process begins at step 405, wherein the base product module and the additive module are decoupled. At next step 410, the desired variable characteristic intensity is determined. Thus, for example, the consumer or end-user can determine the desired intensity of the variable characteristic in the resultant product from the range of intensities associated with the variable characteristic.

At next step 415, the approximate number of additive partitions to achieve the desired variable characteristic intensity is determined. Thus for example, if a consumer or end-user desires a characteristic intensity at, or approximately near, a midpoint of a range of intensities for the desired characteristic, the approximate number of additive partitions would be determined to be approximately one-half of a unit of additive. Similarly, if the consumer or end-user wishes the end product to have an intensity characteristic at approximately one-third of the value between a lower end of the range of characteristics intensities to a higher end of the range of characters intensities, the approximate number of additive partitions would be approximately one-third of a unit of additive. It will be understood to one skilled in the art that other configurations can also be employed.

At next step 420, the determined number of additive partitions and the base product are combined, resulting in an end product. Thus, the user or consumer can generate a customizable consumer product with a characteristic intensity at an approximate intensity level to suit the consumer's desired intensity without requiring significant end-user or consumer customization or manipulation.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A consumer product, comprising:
a base product comprising one or more base characteristics and at least one variable characteristic with an intensity at a low end of a range of intensities;
an additive product comprising the variable characteristic and at least one of the one or more base characteristics; and
the additive product configured to increase the intensity of the variable characteristic towards a high end of the range of intensities when combined with the base product to form a resultant product.

2. The consumer product as recited in claim 1, further comprising:
a base product module comprising the base product; and
an additive module coupled to the base product module and comprising the additive product.

3. The consumer product as recited in claim 1, further comprising a delivery control module comprising the additive product and configured to regulate disbursement of the additive product.

4. The consumer product as recited in claim 1, further comprising a measurement module comprising the additive product and configured to identify substantially equivalent portions of the additive product.

5. The consumer product as recited in claim 1, further comprising:
a base product module comprising the base product;
an additive module coupled to the base product module and comprising the additive product;
a delivery control module coupled to the additive module and configured to regulate disbursement of the additive product from the additive module; and
a measurement module coupled to the additive module and configured to identify substantially equivalent portions of the additive product.

6. The consumer product as recited in claim 1, wherein:
the base product further comprises a salsa dip; and
the variable characteristic further comprises a spiciness.

7. The consumer product as recited in claim 1, wherein:
the base product further comprises a laundry detergent; and
the variable characteristic further comprises a fragrance.

8. The consumer product as recited in claim 1, wherein:
the base product further comprises a salad dressing; and
the variable characteristic further comprises a high-caloric ingredient-based flavor.

9. The consumer product as recited in claim 1, wherein:
the base product further comprises a sauce; and
the variable characteristic further comprises a spiciness.

10. The consumer product as recited in claim 1, wherein:
the base product further comprises a jelly; and
the variable characteristic further comprises a sweetness.

11. The consumer product as recited in claim 1, wherein:
the base product further comprises a chili; and
the variable characteristic further comprises a spiciness.

12. The consumer product as recited in claim 1, wherein:
the base product further comprises a beverage mixer; and
the variable characteristic further comprises a sweetness.

13. The consumer product as recited in claim 1, wherein:
the base product further comprises a household cleaner; and
the variable characteristic further comprises a fragrance.

14. The consumer product as recited in claim 1, wherein:
the base product further comprises a nutrient replacement drink; and
the variable characteristic further comprises an electrolyte concentration.

15. A method, comprising:
generating a base product comprising one or more base characteristics and at least one variable characteristic with an intensity at a low end of a range of intensities;
generating an additive product comprising the variable characteristic and at least one of the one or more base characteristics; and
configuring the additive product to increase the intensity of the variable characteristic towards a high end of the range of intensities when combined with the base product to form a resultant product.

16. The, method as recited in claim 15, further comprising:
packaging the base product in a base product module;
packaging the additive product in an additive module; and
coupling the base product module and the additive module.

17. The method as recited in claim 15, further comprising:
packaging the additive product in a delivery control module; and
configuring the delivery control module to regulate disbursement of the additive product.

18. The method as recited in claim 15, further comprising:
packaging the additive product in a measurement module; and
configuring the measurement module to identify substantially equivalent portions of the additive product.

19. The method as recited in claim 15, further comprising:
packaging the additive product in an additive module; and
configuring the additive module to partition the additive module into one or more subunits substantially equivalent in volume.

20. The method as recited in claim 15, further comprising:
packaging the base product in a base product module;
packaging the additive product in an additive module;
coupling the base product module and the additive module;
coupling a measurement module to the additive module, the measurement module configured to identify substantially equivalent portions of the additive product; and
coupling a delivery control module to the additive module, the delivery control module configured to regulate disbursement of the additive product.

21. The method as recited in claim 15, wherein:
the base product further comprises a salsa dip; and
the variable characteristic further comprises a spiciness.

22. The method as recited in claim 15, wherein:
the base product further comprises a laundry detergent; and
the variable characteristic further comprises a fragrance.

23. A consumer product, comprising:
a salsa dip comprising a first flavor characteristic, a first tomato-content characteristic, a first viscosity characteristic, and a first spiciness characteristic, wherein the spiciness characteristic comprises an intensity at a low end of a range of intensities;
a salsa container configured to store the salsa dip;
a heat additive comprising a second spiciness characteristic and a second viscosity characteristic;
wherein the second spiciness characteristic comprises an intensity at a higher intensity than the intensity of the first spiciness characteristic;
a heat additive container configured to store the heat additive, to identify one or more substantially equivalent subunits of the heat additive by volume, and to regulate flow of the heat additive from the heat additive container;
wherein the heat additive is configured so that when combined with the salsa dip to form a prepared salsa, the prepared salsa comprises a second flavor characteristic, a second tomato-content characteristic, a third viscosity characteristic, and a third spiciness characteristic;
wherein the second flavor characteristic is substantially similar to the first flavor characteristic and the second tomato-content characteristic is substantially similar to the first tomato-content characteristic; and
wherein the third spiciness characteristic comprises an intensity at a higher intensity than the intensity of the first spiciness characteristic.
